(19) United States
(12) Patent Application Publication
(10) Pub. No.: US 2025/0377466 A1
(43) Pub. Date: Dec. 11, 2025

(54) TIME FREE POSITION DETERMINATION OF A ROVING RECEIVER USING A REFERENCE RECEIVER

(71) Applicant: Albora Technologies Limited, London (GB)

(72) Inventors: Miquel Ribot, Barcelona (ES); Adrià Gusi, Barcelona (ES); Xiao Liu, Barcelona (ES); Pau Closas, London (GB)

(21) Appl. No.: 19/312,208

(22) Filed: Aug. 27, 2025

Related U.S. Application Data
(63) Continuation-in-part of application No. 17/127,803, filed on Dec. 18, 2020, now abandoned.

(51) Int. Cl. G01S 19/43; G01S 19/29; G01S 19/30

(52) U.S. Cl. CPC G01S 19/43; G01S 19/29; G01S 19/30

(57) ABSTRACT

The time-free position determination of a roving receiver using a reference receiver without benefit of a known receiver time includes the acquisition from a real-time kinematic (RTK) roving receiver of a snapshot position of the receiver for a single epoch from a constellation of global positioning satellites. The snapshot includes satellite time-free observables lacking both satellite transmitted timestamps and also rough timestamps from either a local clock onboard the receiver, or from network protocol data established in a computer communications network. Concurrently, baseline position data is retrieved for a fixed receiver which had been received from the constellation including time-referenced observables. Finally, time and position data is produced for the receiver by compositing the time-free observables with the time referenced observables with the rough timestamps as an unknown.

### CROSS-REFERENCE TO RELATED APPLICATIONS

This application is a Continuation-in-Part of U.S. patent application Ser. No. 17/127,803, filed Dec. 18, 2020, the entirety of which is incorporated herein by reference.

### BACKGROUND OF THE INVENTION

### Field of the Invention

The present invention relates to the field of real-time kinematic (RTK) position determination for RTK roving receivers in satellite-based global positioning systems.

### Description of the Related Art

RTK positioning is a satellite navigation technique used to enhance the precision of position data derived from satellite-based positioning systems referred to as global navigation satellite systems (GNSS) and exemplified by the global positioning system (GPS), Global Navigation Satellite System (GLONASS), Galileo, NavIC and BeiDou. RTK employs measurements of the phase of the carrier wave of each satellite signal received in an RTK roving receiver, in addition to the information content of the signal and then relies upon a single reference station or interpolated virtual station in order to provide real-time corrections. The result is typically on the order of centimeter-level accuracy.

A traditional RTK roving receiver both receives satellite signals and also processes the signals in order to produce position data. The latter exercise substantially increases the processing resource requirements of the underlying host computing platform of the RTK roving receiver. Of course, increased processing requirements may result in a larger physical footprint, and therefore geometry and weight of the RTK roving receiver, thereby limiting the utility of the RTK roving receiver in many Internet of Things (IoT) applications in which a small, lightweight footprint is required. As well, a host computing platform able to deliver the requisite processing resources for RTK necessarily draws more power requiring a larger power source, e.g. a battery of substantial size and weight, thus only compounding the problem of RTK for smaller, more lightweight applications.

RTK roving receivers generally require near continuous acquisition of positioning data from a satellite constellation in order to support the real-time positioning of a device. Because the RTK roving receiver in this instance receives positioning data over several epochs, ample data exists—particularly time-based data including satellite provide rough timestamps—in order to tune the raw positioning information received from the satellite constellation into accurate positioning information. But, the continuous acquisition of positioning data over a number of epochs also is not without consequence. Specifically, the continuous acquisition of positioning data consumes power which, again, inhibits the ability to miniaturize the RTK roving receiver.

Yet, without ingesting positioning data over a number of epochs including rough timestamps from the satellite, insufficient time-based data will be present for use in properly tuning the raw satellite harvested positioning data. In particular, where only a single epoch of positioning data is received from a satellite in an RTK roving receiver prior to position resolution, no rough timestamp information will be available from the satellites of the constellation, or even from the network coupling the RTK roving receivers to the host computing platform. As such, resolving accurate positioning of the RTK roving receiver after only a single epoch of positioning data with only time-free observables is not possible.

### BRIEF SUMMARY OF THE INVENTION

Embodiments of the present invention address deficiencies of the art in respect to RTK positioning and provide a novel and non-obvious method for time-free position determination of an RTK roving receiver using a reference receiver. Embodiments of the present invention also includes a novel and non-obvious data processing system adapted to produce a position estimate of an RTK roving receiver using a reference receiver without the benefit of rough timestamps. Embodiments of the present invention yet further include a novel and non-obvious computer program product adapted for the production of a position estimate of an RTK roving receiver using a reference receiver without the benefit of rough timestamps.

In an embodiment of the invention, a method for time-free position determination of a roving receiver includes the acquisition from a GNSS RTK roving receiver from over a computer communications network in a cloud executing process, a snapshot position of the RTK roving receiver received by the roving receiver for a single epoch from a constellation of global positioning satellites. The snapshot position includes multiple different satellite time-free observables. By time free, it is meant that the satellite time-free observables lack both satellite transmitted rough timestamps and also rough timestamps from either a local clock onboard the snapshot receiver, or from network protocol data established in the computer communications network.

The method additionally includes the retrieval into the cloud executing process from over the computer communications network of a baseline position data for a GNSS fixed receiver received from the constellation and comprising time-referenced observables. Finally, the method includes the production of time and position data for the RTK roving receiver by compositing in the cloud executing process the time-free observables of the snapshot with the time referenced observables of the position data of the fixed receiver of the base station, with the rough timestamps treated as an unknown. In this way, the snapshot received from the satellite constellation in the RTK roving receiver over only a single epoch can be tuned to produce centimeter-level accuracy despite the absence of time-referenced observables in the snapshot position—especially the rough timestamp information.

In one aspect of the embodiment, the time-free observables are a set of code-range measurements and corresponding carrier phase measurements. In another aspect of the embodiment, the compositing includes computing an integer ambiguity resolution (IAR) for the snapshot position based upon both the code-range measurements and also the carrier phase measurements of the time-free observables and also code-range measurements and carrier-phase measurements of the time-referenced observables. In this regard, the time-free observables are pre-processed prior to IAR by first extrapolating a set of full pseudo-ranges for the snapshot position utilizing previously acquired time and position data for the RTK roving receiver and by second pre-aligning each of the carrier phase measurements with integers that correspond to a magnitude of associated code-range measurements.

In another aspect of the embodiment, the IAR is a three-step process. The three-step process includes first calculating a float solution for both the code-range measurements and also the carrier phase measurements of the time-free observables and also both the code-range measurements and also the carrier-phase measurements of the time-referenced observables, the float solution being subjected to a double difference process to produce a double difference vector. Second, an integer estimation is performed upon the double difference vector to produce an integer vector. Finally, a re-calculation is performed of the float solution with the integer vector in order to produce the IAR.

In another embodiment of the invention, a data processing system is adapted for time-free position determination of a roving receiver using a reference receiver without the benefit of rough timestamp data from the satellite or network. The system includes a host computing platform which includes one or more computers, each with memory and at least one processor, and a communicative coupling over a computer communications network to a fixed receiver adapted to receive baseline position data for the fixed receiver from a constellation of global positioning satellites, the data including time-referenced observables. The system yet further includes a communicative coupling over the computer communications network to a multiplicity of RTK roving receivers.

Each corresponding one of the RTK roving receivers is adapted to receive time-free observables disposed within a snapshot position of the corresponding one of the RTK roving receivers that has been received only for a single epoch from a constellation of global positioning satellites. The time-free observables include a multiplicity of satellite time-free observables lacking both satellite transmitted timestamps and also rough timestamps from either a local clock onboard the corresponding one of the RTK roving receivers, or from network protocol data established in the computer communications network.

Finally, the system includes a time-free position determination module. The module includes computer program instructions which are enabled while executing in the host computing platform to perform a process for time-free position determination of a roving receiver using a reference receiver without the benefit of rough timestamp data from the satellite or network. The process includes acquiring the snapshot position of the corresponding one of the RTK roving receivers. The process also includes retrieving the baseline position data of the fixed receiver. Finally, the process includes producing time and position data for the corresponding one of the RTK roving receivers by compositing in the cloud executing process the time-free observables of the snapshot with the time referenced observables of the position data of the fixed receiver of the base station, with the rough timestamps as an unknown.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is pictorial illustration of a process for time-free position determination of a roving receiver using a reference receiver;

FIG. 2 is a schematic diagram showing a computing architecture for a data processing system adapted for time-free position determination of a roving receiver using a reference receiver; and,

FIG. 3 is a flow chart illustrating a process for time-free position determination of a roving receiver using a reference receiver.

### DETAILED DESCRIPTION OF THE INVENTION

Embodiments of the invention provide for time-free position determination of a roving receiver using a reference receiver. In accordance with an embodiment of the inventive arrangements, over a single epoch, time-free positioning data is received in a GNSS RTK roving receiver from four or more positioning satellites in a global positioning satellite constellation. The time-free positioning data includes by way of example, both code-range measurements and corresponding carrier phase measurements. As well, baseline positioning data for a fixed receiver which differs from the RTK roving receiver may be received from the same constellation, the baseline positioning data including time-referenced observables. Finally, the time-free positioning data of the snapshot position are composited with the time referenced observables of the baseline position data to produce time and position data for the RTK roving receiver, by computing an integer ambiguity resolution (IAR) for the time-free positioning data based upon both the code-range measurements and also the carrier phase measurements and also code-range measurements and carrier-phase measurements of the time-referenced observables.

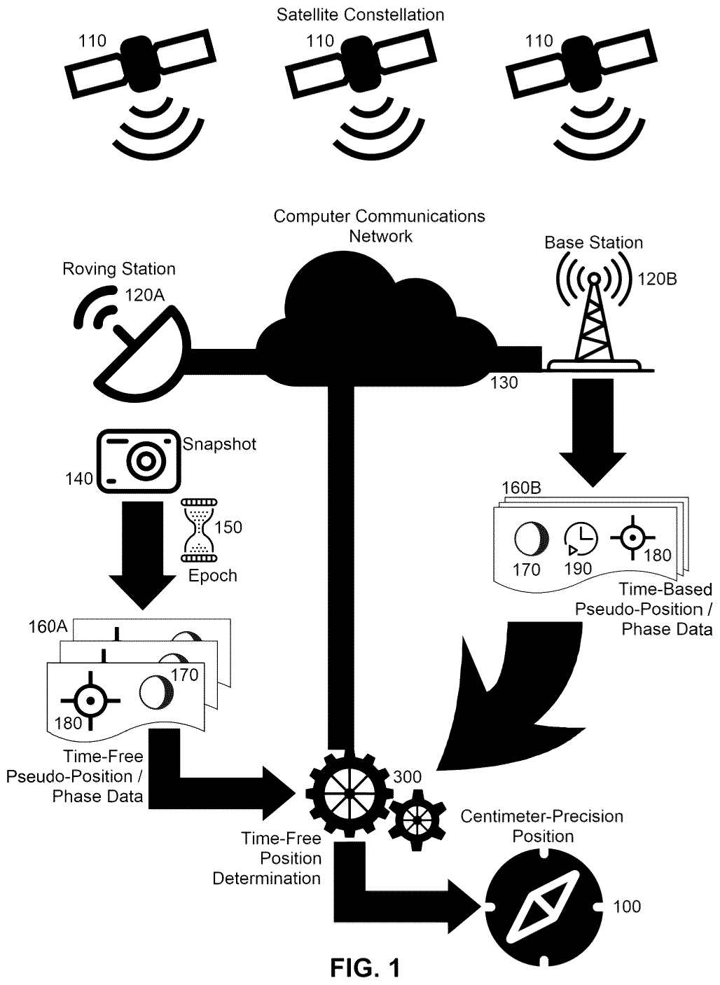

In further illustration, FIG. 1 pictorially shows a process for time-free position determination of an RTK roving receiver using a fixed reference receiver. As shown in FIG. 1, a roving station 120A with an RTK roving receiver receives a snapshot 140 of a time-free set of observables 160A of carrier phase measurements 170 and code-range measurements 180 over a single epoch 150 from four or more satellites 110 in a GNSS constellation. The time-free set of observables 160A is devoid of a rough timestamp applied by the satellites 110. Concurrently, a base station 120B receives time-based observables 160B from the satellites 110 in the GNSS constellation including not just carrier phase measurements 170 and code-range measurements 180 but also timing information 190 regarding the transmission of the carrier phase measurements 170 and code-range measurements 180.

Both the roving station 120A and the base station 120B provide the respective observables 160A, 160B over computer communications network 130 to time-free position determination module 300. The time-free position determination module 300 tunes the time-free observables 160A of carrier phase measurements 170 and code-range measurements 180 from the snapshot 140 using the time-based observables 160B of the carrier phase measurements 170 and code-range measurements 180 along with the timing information 190 in order to produce a centimeter precision position 100 of the roving station 120A. In this way, the roving station 120A can be of smaller size with reduced power consumption collecting the snapshot 140 over only a single epoch 150 without sacrificing the ability to produce the centimeter-precision position 100 of the roving station 120A.

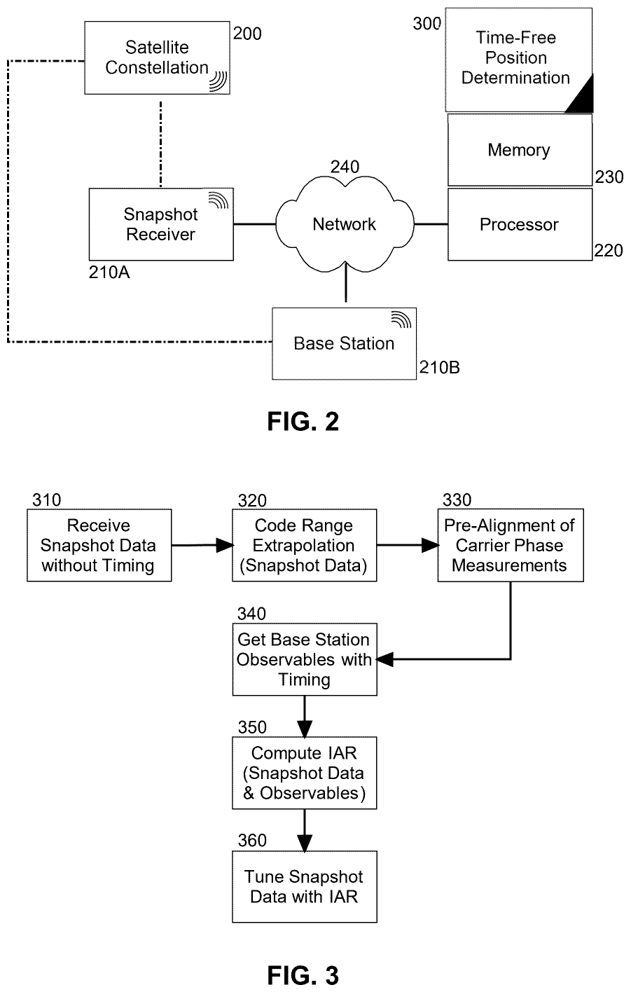

The process described in connection with FIG. 1 can be implemented within a data processing system. In further illustration, FIG. 2 schematic shows a computing architecture for a data processing system adapted for time-free position determination of a roving receiver using a reference receiver. The system includes a host computing platform that includes a processor 220 and memory 230 and is communicatively coupled over computer communications network 240 to both an RTK roving receiver 210A and also a base station 210B, both of which in turn receive positioning data from a satellite constellation 200. A time-free position determination module 300 executes in the memory 230 by the processor 220 of the host computing platform.

The time-free position determination module 300 includes computer program instructions operable upon execution by the processor 220 in the memory 230 to produce a centimeter-precision position of the snapshot receiver 210A by tuning time-free snapshot data received by the RTK roving receiver 210 from the satellite constellation 200 over only a single epoch, with time-based observables received in the base station 210B also from the satellite constellation 200. In this regard, the receiver position, velocity, and clock offset and timestamp when the observables had been computed from the snapshot are each estimated. To that end, the resultant unknown parameter vector is θ=[rr, vr, δtr, b], with “b” denoting a scalar value for the unknown rough timestamp.

The estimation is performed through RTK double differentiation of pseudo-ranges and carrier-phase observables using a least squares procedure. The pseudorange

$${ρ}_{r}^{j}$$

between a receiver r and a satellite j is given by:

$${ρ}_{r}^{j} = ‖ {r}_{r} - {r}^{j} ( b ) ‖ + c ( δ {t}_{r} - δ {t}^{j} ) + {I}_{r}^{j} + {T}_{r}^{j} + {ϵ}_{ρ , r}^{j}$$

where:
rᵣ is the position vector of the RTK roving receiver
r^{j}(b) is the position vector of the satellite j, dependent upon the scalar variable b
c is the speed of light
δtᵣ is the receiver clock error
δt^{j} is the satellite clock error

$${I}_{r}^{j}$$

is the ionospheric delay

$${T}_{r}^{j}$$

is the tropospheric delay

$${ϵ}_{ρ , r}^{j}$$

is the pseudorange measurement noise and multipath

Likewise, the carrier-phase between a receiver r and a satellite J is given by:

$${ϕ}_{r}^{j} = \frac{1}{λ} ‖ {r}_{r} - {r}^{j} ( b ) ‖ + \frac{c}{λ} ( δ {t}_{r} - δ {t}^{j} ) - \frac{1}{λ} {I}_{r}^{j} + \frac{1}{λ} {T}_{r}^{j} + {N}_{r}^{j} + {ϵ}_{ϕ , r}^{j}$$

where:
λ is the wavelength of the carrier signal

$${N}_{r}^{j}$$

is the integer ambiguity

$${ϵ}_{ϕ , r}^{j}$$

is the carrier phase measurement noise and multipath

In particular, the program instructions are operable to first pre-process the time-free snapshot data of both code-range measurements and carrier phase measurements with an extrapolation of a partial set of code-range measurements into a full set of code-range measurements, and then to align the carrier phase measurements according to integer wavelengths. Then, the program instructions are operable to compute IAR for the pre-processed time-free snapshot data of the RTK roving receiver 210A utilizing the time-based observables of the base station 210B. Finally, the computed IAR is applied to the pre-processed time-free snapshot data in order to produce the centimeter-precision position of the RTK roving receiver 210.

In even yet further illustration of the operation of the program instructions of the time-free position determination module 300, FIG. 3 is a flow chart illustrating a process for time-free position determination of a RTK roving receiver using a reference receiver. Beginning in block 310, time-free snapshot received in an RTK roving receiver from a satellite in a GNSS constellation for only a single epoch is retrieved from over a data communications network from the RTK roving receiver. The time-free snapshot lacks a rough timestamp provided by the satellite and the time-free snapshot lacks a rough timestamp provided by the protocol of the network.

In block 320, a code range extrapolation is performed upon the fractional code phases of the snapshot. These fractional values are complemented by full code periods to obtain the distance to the beginning of the starting edge of the secondary code. Then the satellite transmission time can be anchored based on the fact that GNSS secondary code edges are always aligned with the standard GNSS time. After the transmission time has been accurately computed, a common reception time will be set for all the satellites and the full pseudo-ranges are obtained by multiplying speed of light and the time difference between transmission and reception of each satellite signal.

As well, in block 330, a pre-alignment is performed upon the carrier phase measurements of the snapshot. Thereafter, in block 340, time-based observables are retrieved in connection with a base station. Those observables include not only code-range measurements and carrier-phase measurements, but also corresponding timing information pertaining to a time of transmission of the information from respective satellites in the satellite constellation. The involved quantities are defined as

$${t}_{trans} = τ + N * {T}_{c} + Round ( ( {t}_{CT} - {ρ}_{CT} / c ) / {T}_{sc} ) * {T}_{sc} ;$$

P=c*(t_{reception}−tₜᵣₐₙₛ); Where: tₜᵣₐₙₛ is the satellite transmission time for one satellite; t represents the code phase and N represents the number of full primary code periods inside the current secondary code, these two values are computed inside the acquisition module; T_{c} and T_{sc} are the primary and secondary code periods of this satellite, respectively; t_{CT} is the timing solution computed from the Coarse-Time filter which is a rough time and position solution that is an intermediate product of the time-free position determination module 300, and ρ_{CT} is the geometric range from the satellite position and the receiver position solution from the Coarse-Time filter; c is the speed of light; t_{reception} is the common reception time for all satellites and finally P is the full pseudorange for the current satellite

In block 350, an IAR is computed for the extrapolated code-range measurements and the pre-aligned phase measurements, based upon the time-based observables of the base station. For instance, the IAR may be computed as a three-step process beginning with the calculation of a float solution for both the code-range measurements and also the carrier phase measurements of the time-free observables and also both the code-range measurements and also the carrier-phase measurements of the time-referenced observables. The float solution then can be subjected to a double difference process to produce a double difference vector which, in turn, can be integer estimated so as to produce an integer vector. Finally, the float solution can be recalculated with the integer vector in order to produce the IAR. Consequently, the snapshot can be tuned with the computed IAR in block 360 in order to produce a centimeter-precise position of the snapshot receiver.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “include”, “includes”, and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for time-free position determination of a roving receiver using a reference receiver without benefit of a known receiver time, the method comprising:
acquiring from a global navigation satellite system (GNSS) real-time kinematic (RTK) roving receiver from over a computer communications network in a cloud executing process, a snapshot position of the RTK roving receiver received by the roving receiver for a single epoch from a constellation of global positioning satellites and comprising a multiplicity of satellite time-free observables lacking both satellite transmitted timestamps and also rough timestamps from either a local clock onboard the RTK roving receiver, or from network protocol data established in the computer communications network;
retrieving into the cloud executing process from over the computer communications network, baseline position data for a GNSS fixed receiver received from the constellation and comprising time-referenced observables;
producing time and position data for the RTK roving receiver by compositing in the cloud executing process the time-free observables of the snapshot with the time referenced observables of the position data of the fixed receiver of the base station, with the rough timestamps as an unknown.

2. The method of claim 1, wherein the time-free observables received in the RTK roving receiver are a set of code-range measurements and a set of carrier phase measurements corresponding to the code-range measurements.

3. The method of claim 2, wherein the compositing comprises computing an integer ambiguity resolution (IAR) for the snapshot position based upon both the code-range measurements and also the carrier phase measurements of the time-free observables and also code-range measurements and carrier-phase measurements of the time-referenced observables.

4. The method of claim 3, wherein the time-free observables are pre-processed prior to IAR by first extrapolating a full set of code-range measurements for the snapshot position utilizing previously acquired time and position data for the RTK roving receiver and by second pre-aligning each of the carrier phase measurements with integers that correspond to a magnitude of associated code-range measurements.

5. The method of claim 3, wherein the IAR is a three-step process that includes:
first a calculation of a float solution for both the code-range measurements and also the carrier phase measurements of the time-free observables with the rough timestamps of the code-range measurements and the carrier phase measurements unknown, and also both the code-range measurements and also the carrier-phase measurements of the time-referenced observables, the float solution being subjected to a double difference process to produce a double difference vector;
second, an integer estimation of the double difference vector to produce an integer vector; and,
third, a re-calculation of the float solution with the integer vector in order to produce the IAR.

6. A data processing system adapted for time-free position determination of a roving receiver using a reference receiver, the system comprising:
a host computing platform comprising:
one or more computers, each comprising memory and at least one processor,
a communicative coupling over a computer communications network to a fixed receiver adapted to receive baseline position data for the fixed receiver from the constellation, the baseline position data comprising time-referenced observables; and,
a communicative coupling over the computer communications network to a multiplicity of global navigation satellite system (GNSS) real-time kinematic (RTK) roving receivers, each corresponding one of the RTK roving receivers being adapted to receive time-free observables disposed within a snapshot position of the corresponding one of the RTK roving receivers received therein for a single epoch from a constellation of global positioning satellites, the time-free observables comprising:
a multiplicity of satellite time-free observables lacking both satellite transmitted timestamps and also rough timestamps from either a local clock onboard the corresponding one of the RTK roving receivers, or from network protocol data established in the computer communications network, and,
a time-free position determination module comprising computer program instructions enabled while executing in the host computing platform to perform:
acquiring the snapshot position of the corresponding one of the RTK roving receivers;
retrieving the baseline position data of the fixed receiver; and,
producing time and position data for the corresponding one of the RTK roving receivers by compositing in the cloud executing process the time-free observables of the snapshot with the time referenced observables of the position data of the fixed receiver of the base station, with the rough timestamps as an unknown.

7. The system of claim 6, wherein the time-free observables received in the corresponding one of the RTK roving receivers are a set of code-range measurements and a set of carrier phase measurements corresponding to the code-range measurements.

8. The system of claim 7, wherein the compositing comprises computing an integer ambiguity resolution (IAR) for the snapshot position based upon both the code-range measurements and also the carrier phase measurements of the time-free observables and also code-range measurements and carrier-phase measurements of the time-referenced observables.

9. The system of claim 8, wherein the time-free observables are pre-processed prior to IAR by first extrapolating a full set of code-range measurements for the snapshot position utilizing previously acquired time and position data for the corresponding one of the RTK roving receivers and by second pre-aligning each of the carrier phase measurements with integers that correspond to a magnitude of associated code-range measurements.

10. The system of claim 9, wherein the IAR is a three-step process that includes:
first a calculation of a float solution for both the code-range measurements and also the carrier phase measurements of the time-free observables with the rough timestamps of the code-range measurements and the carrier phase measurements unknown, and also both the code-range measurements and also the carrier-phase measurements of the time-referenced observables, the float solution being subjected to a double difference process to produce a double difference vector;
second, an integer estimation of the double difference vector to produce an integer vector; and,
third, a re-calculation of the float solution with the integer vector in order to produce the IAR.

11. A computer program product for time-free position determination of a roving receiver using a reference receiver, the computer program product including a computer readable storage medium having program instructions embodied therewith, the program instructions executable by a device to cause the device to perform a method including:
acquiring from a global navigation satellite system (GNSS) real-time kinematic (RTK) roving receiver from over a computer communications network in a cloud executing process, a snapshot position of the RTK roving receiver received by the RTK roving receiver for a single epoch from a constellation of global positioning satellites and comprising a multiplicity of satellite time-free observables lacking both satellite transmitted timestamps and also rough timestamps from either a local clock onboard the RTK roving receiver, or from network protocol data established in the computer communications network;
retrieving into the cloud executing process from over the computer communications network, baseline position data for a GNSS fixed receiver received from the constellation and comprising time-referenced observables;
producing time and position data for the RTK roving receiver by compositing in the cloud executing process the time-free observables of the snapshot with the time referenced observables of the position data of the fixed receiver of the base station, with the rough timestamps as an unknown.

12. The computer program product of claim 11, wherein the time-free observables received in the RTK roving receiver are a set of code-range measurements and a set of carrier phase measurements corresponding to the code-range measurements.

13. The computer program product of claim 12, wherein the compositing comprises computing an integer ambiguity resolution (IAR) for the snapshot position based upon both the code-range measurements and also the carrier phase measurements of the time-free observables and also code-range measurements and carrier-phase measurements of the time-referenced observables.

14. The computer program product of claim 13, wherein the time-free observables are pre-processed prior to IAR by first extrapolating a full set of code-range measurements for the snapshot position utilizing previously acquired time and position data for the RTK roving receiver and by second pre-aligning each of the carrier phase measurements with integers that correspond to a magnitude of associated code-range measurements.

15. The computer program product of claim 13, wherein the IAR is a three-step process that includes:
first a calculation of a float solution for both the code-range measurements and also the carrier phase measurements of the time-free observables with the rough timestamps of the code-range measurements and the carrier phase measurements unknown, and also both the code-range measurements and also the carrier-phase measurements of the time-referenced observables, the float solution being subjected to a double difference process to produce a double difference vector;
second, an integer estimation of the double difference vector to produce an integer vector; and,
third, a re-calculation of the float solution with the integer vector in order to produce the IAR.
